(19) United States
(12) Patent Application Publication
(10) Pub. No.: US 2010/0021704 A1
(43) Pub. Date: Jan. 28, 2010

(54) Organic silver complex compound used in paste for conductive pattern forming

(76) Inventors: Sung-Ho Yoon, Daejeon (KR); So-Won Kim, Daejeon (KR); Sang-Ki Chun, Daejeon (KR); Dong-Wook Lee, Daejeon (KR); Seoung-Wook Kim, Daejeon (KR); Won-Jong Kwon, Daejeon (KR)

Correspondence Address: MCKENNA LONG & ALDRIDGE LLP, 1900 K STREET, NW, WASHINGTON, DC, 20006, US

(21) Appl. No.: 12/311,345

(22) PCT Filed: Sep. 21, 2007
(86) PCT No.: PCT/KR2007/004672

§ 371 Date: Mar. 27, 2009

(30) Foreign Application Priority Data
Sep. 29, 2006 (KR) 1020060096502
Sep. 29, 2006 (KR) 1020060096522

(51) Int. Cl. C07F 1/10; H01B 1/12; B32B 3/00

(52) U.S. Cl. 428/209; 556/116; 554/74; 252/519.2; 428/195.1

(57) ABSTRACT

Disclosed is an organic silver complex compound in which an organic ligand, containing an amine group (—NH₂) and a hydroxyl group (—OH), is bonded with aliphatic silver (Ag) carboxylate at an equivalent ratio of 2:1 to form a complex. Also disclosed is a conductive paste comprising: a silver source selected from the group consisting of silver oxide powder, silver powder and silver flake; and organic silver complex compound in which an organic ligand, containing an amine group and a hydroxyl group, is bonded with an organic silver compound to form a complex. The organic silver complex compound has high solubility in a solvent and is present in the liquid state at room temperature. Thus, an extra solvent is not used in a conductive pattern-forming paste containing the complex compound or is used in a small amount, such that the content of silver in the conductive pattern-forming paste can be increased. Also, the conductive pattern-forming paste containing the complex compound has high viscosity, and thus shows excellent stability without adding a dispersant and, at the same time, is easily industrially applied.

### TECHNICAL FIELD

The present invention relates to an organic silver complex compound, which can be used in a conductive paste, and to a conductive paste containing the same.

### BACKGROUND ART

Prior methods for forming conductive patterns on a substrate include etching, vacuum evaporation and screen printing methods, but such methods have problems in that they require complex and lengthy processes, cause a great loss of raw materials, are expensive and cause environmental pollution. To solve these problems, inkjet techniques or roll-printing methods have been suggested, and they can minimize the loss of raw materials, form conductive patterns using a simple process, and fabricate fine patterns suitable for electronic devices, which become gradually smaller.

Such inkjet methods or roll-printing methods use simple processes and are inexpensive, compared to other methods, but the fabrication of suitable ink or paste should be preceded. That is, said ink or paste should have a very high content of silver for excellent conductivity after calcination and also satisfy viscosity, surface tension, stability and the like, which are physical properties required for inkjet printing and roll printing. Furthermore, recently, printing techniques, which use flexible and inexpensive polymer substrates such as PET, have been developed, but these techniques have a limitation in that calcining temperature should be low, because such substrates have low glass transition temperature (Tg).

For this reason, methods for forming conductive patterns using the inkjet or roll printing methods are not yet industrially applied, even though the inkjet or roll printing methods have many advantages.

In order to satisfy the requirements of said ink or paste, various studies on various kinds of organic silver carboxylates and additives have been conducted. “electronic structure of layered silver carboxylates”, Journal of applied physics, 1998, 84, pp 887, mentions that organic silver carboxylates substantially have a dimeric coordination complex polymer. This polymer form is considered to be the direct cause of low solubility and non-uniform dispersion in a solution or a dispersant.

Korean Patent Publication No. 10-2006-0028350 discloses an organic silver composition solution, which is prepared by allowing a silver (Ag)-containing salt to react with a straight-chain or aromatic compound, containing an alcohol group, and straight chain or aromatic compound, containing an amine group, in an alcohol solvent, and has liquid fluidity suitable for inkjet printing. The organic silver composition solution disclosed in the patent publication has a silver (Ag) salt content of 20-40 wt %, which is higher than those of prior organic silver compositions, but the actual silver content thereof is lower than the above-described numerical value, because the silver salt consists of silver cations and anions. Also, the organic silver composition solution in the patent publication is close to a suspension rather than a solution, and thus has a shortcoming in that large amounts of additives should be used to maintain the dispersibility of the silver composition solution.

“Novel preparation of monodispersed silver nanoparticles via amine adducts derived from insoluble silver myristate in tertiary alkylamine”, Journal of materials chemistry, 2003, 13, pp. 2064, discloses a technology of synthesizing nanoparticles by reducing silver ions (Ag⁺) to silver with amine at about 80-130° C. However, ink or paste, which employ this reducing property of amine, is not yet known.

Meanwhile, a general conductive paste is a dispersion of conductive metal particles in resin or the like, and as the conductive metal particles, silver (Ag) particles, which have high electrical conductivity and are difficult to oxidize, are mainly used. Among conductive pastes, pastes for high-temperature calcination may have a resistivity of less than about 6 μΩ cm by bonding metal particles with each other through high-temperature heating at 500° C. or above to make a continuous conductive film, but have a problem in that substrates to which the pastes can be applied are limited due to high calcining temperature. Also, polymer-type pastes are prepared by mixing silver particles with resin in order to increase adhesion to substrates, the dispersibility of metal particles, and printing properties. In the case of the polymer-type pastes, resin is cured when it is heated at a temperature of about 150° C., and thus the contact between metal particles occurs, such that a conductive film can be formed. The polymer-type paste can exhibit a resistivity of less than about 15 μΩ cm, but have a shortcoming in that the electrical conductivity is not sufficient compared to that of the pastes for high-temperature calcination.

Silver compound pastes for low-temperature calcination, which were recently designed in order to overcome this shortcoming, are characterized in that they have a relatively high electrical conductivity, like the pastes for high-temperature calcination, and, at the same time, have low calcining temperature, like the polymer-type pastes.

The silver compound pastes for low-temperature calcination generally contain silver oxide particles and tertiary fatty acid silver salts. When the silver oxide and the tertiary fatty acid salt are mixed with each other to make a paste, the tertiary fatty acid silver salt, dissolved in an organic solvent, serves as a lubricant for powdering silver oxide to make fine particles having a size of several hundreds of nanometers (nm) and, at the same time, functions to stabilize the dispersion of silver oxide fine particles.

Moreover, when the silver compound paste is heated, silver oxide can be reduced to silver particles at low temperature and, at the same time, the tertiary fatty acid silver salt can be decomposed to deposit silver. The silver deposited from the fatty acid silver salt can be bonded between the silver particles produced by reduction from silver oxide, thus forming a dense conductive film. That is, the silver compound paste for low-temperature calcination may have a resistivity of less than 6 μΩ cm through the bonding between silver particles without using an insulation material such as resin.

However, to calcine the silver compound paste for low-temperature calcination, a heating process should be carried out at a temperature of about 150° C. for at least 20 minutes. Thus, in a roll printing process which uses a plastic film as a substrate, there are problems in that it is difficult to use a substrate, such as a PET film which is generally used, and in addition, a process time for calcination is long.

Also, the need to use a silver salt of tertiary fatty acid, which is easily dissolved in a specific solvent and has more than 10 carbon atoms, can make it difficult to control the physical properties of the paste. As the specific solvent for dissolving the tertiary fatty acid silver salt, BCA (butyl carbitol acetate) or terpineol is mainly used. These solvents cause the deterioration in the precision of fine printed patterns, because they easily swell silicone resin, which is frequently used in pattern printing. Moreover, when the silver salt of tertiary fatty acid having more than 10 carbon atoms is used in the paste for low-temperature calcination, there are shortcomings in that the paste causes low initial density of deposited thin film when it is applied to a substrate, the thickness of the thin film is greatly different between before and after calcination due to the relatively low silver content of the paste, and thus, the resulting conductive film has high sheet resistance.

A primary fatty acid silver salt, which can increase application density and silver content, is known to have poor solubility in general organic solvents. This is because the organic silver salt forms the dimeric coordination complex polymer as described above. Thus, it is difficult to use the primary fatty acid silver salt itself in the silver paste compound paste for low-temperature calcination.

### DISCLOSURE OF THE INVENTION

Through related studies, the present inventors have found that an organic silver complex compound, obtained by making a fatty acid silver salt into the form of a single molecular complex, has high solubility in solvents and is present in the liquid state at room temperature. Particularly, an organic silver complex compound, which is present in the liquid state at room temperature and, at the same time, suitable as a paste solvent due to high viscosity, could be prepared by coordinately bonding two molecules of alcoholamine to one molecule of silver carboxylate.

Also, the present inventors have found that, when the organic silver complex compound is mixed with silver oxide, the reduction of silver oxide to silver metal occurs through an exothermic reaction at low temperature. In addition, the present inventors have found that, because the organic silver complex compound of the present invention is in the liquid state at room temperature, it can eliminate the use of a solvent, and thus can overcome the solubility problem of the prior organic silver salt, and also can minimize problems which can occur upon the use of organic solvents such as BCA or terpineol.

The present invention is based on these findings, and it is object of the present invention to provide a novel organic silver complex compound and a conductive paste containing the same.

In one aspect, the present invention provides an organic silver complex compound in which an organic ligand, containing an amine group (—NH₂) and a hydroxyl group (OH), is bonded with aliphatic silver (Ag) carboxylate at an equivalent ratio of 2:1 to form a complex.

In another aspect, the present invention provides a conductive paste, comprising: a silver source selected from the group consisting of silver oxide powder, silver powder and silver flake; and an organic silver complex compound in which an organic ligand, containing an amine group and a hydroxyl group, is bonded with an organic silver compound to form a complex.

Hereinafter, the present invention will be described in detail.

The present invention provides an organic silver complex compound in which an organic ligand, containing an amine group and a hydroxyl group, is coordinately bonded to an organic silver compound to form a complex. Herein, the equivalent ratio between the organic ligand, containing an amine group and a hydroxyl group, and the organic silver compound, is preferably 2:1, and the organic silver compound is not specifically limited, but is preferably an aliphatic carboxylic acid.

Generally, most silver-containing compounds except for silver nitrate have poor solubility in water or general solvents, and are difficult to apply industrially. Such poor solubility is mainly attributable to the formation of coordination polymers by organic silver compounds (e.g., silver carboxylate). That is, when silver in an organic silver compound, and an organic ligand forms coordinate bonds, two or more different coordinate bonds can be formed, so that two-dimensionally linked polymers can be formed. When such coordination polymers are formed, the silver-containing compounds can be poorly soluble in solvents.

In the present invention, in order to overcome such a problem, the ligand, containing an amine group and a hydroxyl group, is allowed to react with the organic silver compound at an equivalent ratio of 2:1, so that the organic silver compound can be converted into a single molecular form, which can have increased solubility in a solvent. The organic silver complex compound thus prepared can be in the liquid state at room temperature.

As shown in FIG. 1, when Ag ions bind to two molecules of alcoholamine, the amine group binds to Ag ions, and thus Ag ions cannot bind to another organic silver compound. Accordingly, the formation of coordination polymers is suppressed, and the organic silver compound becomes a single molecule form, and thus is present in the liquid state at room temperature.

This organic silver complex compound, which is in the liquid state at room temperature, has fluidity, and thus can serve as a solvent. For example, when it is used alone or in a mixture with silver oxide or silver nanoparticles to prepare a paste, a paste having viscosity suitable for the formation of conductive patterns can be prepared without using an extra solvent. Also, because an organic silver compound (e.g., silver carboxylate) can be prepared into a room temperature eutectic salt regardless of the carbon chain length, a paste prepared from the organic silver compound may have an increased solid content. Moreover, the relative content of silver in the organic silver complex compound can be optionally controlled by changing the kinds of organic silver compound and organic ligand, which is coordinately bonded to the organic silver compound.

Furthermore, because the amine coordinately bonded to silver can also function as a reducing agent, a conductive pattern consisting of silver nanoparticles can also be formed by reducing the silver of the organic silver complex compound to silver metal during heating after applying the organic silver complex compound-containing paste to a substrate.

It is known that the hydroxyl group does not strongly bind to the silver of the organic silver compound, and the non-coordinated hydroxyl group can serve to increase the solubility of the organic silver complex compound and to give viscosity by increasing the number of hydrogen bonds between the complex compound molecules.

Particularly, in the present invention, when the alcohol-amine ligand forms a complex with the organic silver compound at an equivalent ratio of 2:1, two —OH groups are present per molecule of the complex compound, and thus the number of hydroxyl groups is larger than that of the case where the ligand and the organic silver compound form a complex at an equivalent ratio of 1:1 or less. Accordingly, the organic silver complex compound has high viscosity, such that it can be suitably used as a paste solvent.

In the present invention, the organic silver compound is not specifically limited, as long as it is a compound which can form a coordinate bond with the organic ligand, which contains an amine group and a hydroxyl group. The organic silver compound is preferably an aliphatic silver carboxylate, and more preferably a silver salt of a primary, secondary or tertiary fatty acid having 2-20 carbon atoms.

The fatty acid silver salt can be prepared through the salt reaction of silver nitrate (AgNO₃) with fatty acid. Herein, the fatty acid is not specifically limited, as long as it contains one or more carboxyl group (—COO).

Meanwhile, if the organic silver compound is aromatic carboxylate, it can be calcined only at high temperature (e.g., 550° C. for more than 10 minutes) due to high boiling point, and a substrate to be applied with the paste should be limited to a substrate which can be used at high temperature. Thus, if the organic silver complex compound and paste of the present invention are purposed to be used in low-temperature calcination, it is not suitable to use aromatic carboxylate as the organic silver compound.

The prior conductive ink or paste mainly used a silver salt of tertiary fatty acid containing more than 10 carbon atoms as the fatty acid silver salt. This is because, when the carbon chain is very short or the alpha carbon is not tertiary, the fatty acid silver salt has a very low solubility in organic solvent.

When the length of the carbon chain is short, the fatty acid silver salt is relatively strong ionic, and thus it is easily dissolved in, for example, ethanol having a low boiling point, but is not dissolved in organic solvents having a high boiling point. Also, when the alpha carbon is not tertiary, the solubility of the fatty acid silver salt is lowered due to the crystallization of the fatty acid.

However, in the present invention, because the organic ligand(e.g. ehthanolamine) containing an amine group and a hydroxyl group, is coordinately bonded to the organic silver compound(e.g., fatty acid silver salt) to form a complex, the complex compound can be formed, even when fatty acid, which has less than 10 carbon atoms or is primary or secondary, is used. Accordingly, the complex compound has lower crystallinity, and thus can be easily dissolved in organic solvents and can be present in the liquid state at room temperature.

For example, when silver propionate (CH₃CH₂COOAg) forms a complex with ethanolamine, the ionicity and crystallinity of the salt can be lowered due to ethanolamine, and thus the salt can be easily dissolved in solvents and can be present in the liquid state. Meanwhile, it is already known that silver palmitate (CH₃(CH₂)₁₄COOAg) having 16 carbon atoms is crystallized by the alkyl chains, and as in the present invention, it can be easily prepared into an organic silver salt of liquid form, because the distance between the chains is sufficiently increased, due to the formation of a complex in the silver (Ag) parts.

Non-limiting examples of the organic silver compound include silver propionate, silver butyrate, silver pentanoate, silver hexanoate, silver heptanoate, silver octanoate, silver nonate, silver decanoate, silver neodecanoate and the like.

In the present invention, the organic ligand, which contains an amine group and a hydroxyl group and forms a complex with the organic silver compound, may be a primary, secondary, tertiary or quaternary amine substituted with an alcohol group, and non-limiting examples thereof include ethanolamine, diethanolamine, triethanolamine, tetraethanolamine, propanolamine and the like.

The organic ligand, containing an amine group and a hydroxyl group, can be present in the liquid state at room temperature, when it becomes a single molecular form by forming a complex with the organic silver compound. Also, the organic ligand can serve to reduce silver ions to silver metal during a heating process for forming conductive patterns, after the organic silver complex compound is applied to a substrate.

The organic silver complex compound of the present invention can be prepared through a method comprising the steps of:

a) mixing an organic ligand, containing an amine group and a hydroxyl group, with an organic silver compound at an equivalent ratio of 2:1 in a solvent, and allowing the mixture to react; and

b) removing the solvent from the reaction solution.

In the step a), when the organic ligand, containing an amine group and a hydroxyl group, is mixed with the organic silver compound at an equivalent ratio of 2:1 in the solvent, and then the mixture is allowed to react with stirring, a transparent solution, in which the organic silver complex compound of the present invention is dissolved in the solvent, can be obtained. Herein, the organic silver compound may also be used in a slight excess, such that the portion of the organic silver compound, which has not formed a complex with the organic ligand, is precipitated and filtered through a filter.

In the step b), the organic silver complex compound can be collected by removing the solvent from the reaction solution. A method for removing the solvent is not specifically limited, as long as it is a method known to those skilled in the art. For example, vacuum distillation can be used. After the distillation, an excess of the solvent can be removed using diethyl ether or the like, or a method such as vacuum drying or nitrogen blowing may also be used.

The solvent that is used in the reaction may be a solvent for organic chemical reaction, which is known to those skilled in the art, and non-limiting examples thereof include methanol, ethanol, terpineol, butyl carbitol acetate and the like.

Because the organic silver complex compound of the present invention has two OH group per molecule thereof, it can have high viscosity compared to those the prior organic silver compound and organic silver complex compound. For example, at room temperature (25° C.), it can have a viscosity ranging from 50 cPs to 2000 cPs, which is a viscosity suitable for the preparation of a paste. At a viscosity higher than the upper limit of the above-specified range, the complex compound has poor workability and it will be difficult to form uniform conductive patterns on a substrate, and at a viscosity lower than the lower limit of the specified range, the complex compound will have poor dispersibility, the resulting pattern will have small thickness, and it will be difficult to maintain the shape of the pattern.

Meanwhile, because the organic silver complex compound of the present invention has the above-specified viscosity range, it is advantageous in that it can be used as a paste without adding an extra solvent or a thickener. However, depending on the viscosity of a paste to be used, the viscosity of the complex compound may also be controlled by adding an extra solvent or a thickener.

The conductive paste of the present invention may comprise the organic silver complex compound in which the organic ligand, containing an amine group and a hydroxyl group, forms a complex with the organic silver compound. In the organic silver complex compound, the organic ligand, containing an amine group and a hydroxyl group, may be bonded with aliphatic silver carboxylate at an equivalent ratio of 2:1 to form a complex.

Also, the conductive paste may further comprise a silver source selected from the group consisting of silver oxide powder, silver powder and silver flake.

General conductive pastes, particularly pastes for low-temperature calcination, comprise fine silver oxide particles, an organic silver salt, a solvent and other additives. Herein, the organic silver salt is in the solid state at room temperature, and thus dissolved for use. However, because it has low solubility in general organic solvents and is dissolved only in a specific solvent, there is a limitation in increasing the silver content in the paste. Also, a specific solvent (e.g., BCA (butyl carbitol acetate) or terpineol) that is used in the paste causes swelling on a specific substrate (e.g., silicon substrate).

However, the conductive paste of the present invention, applicable to a substrate, can be prepared using only a silver source, selected from the group consisting of silver oxide powder, silver powder and silver flake, and said organic silver complex compound. That is, because the organic silver complex compound is in the liquid state at room temperature, it can serve as a solvent without an extra solvent. Also, because it has higher viscosity than general organic solvents, it can be prepared into a paste without the need to add a separate thickener.

Moreover, because an extra solvent is not added or can be added only in a small amount, the content of silver ions in the paste can be increased that much. Thus, problems of low density and silver content, caused by the addition of an organic solvent, and a problem of the difference in film thickness between before and after calcination, can be markedly improved, and the thickness of conductive patterns can be increased, resulting in an increase in the electrical conductivity of the conductive patterns.

Furthermore, in the prior conductive paste for low-temperature calcination, silver oxide is reduced to silver particles, only when the paste is heated to a temperature of at least 150° C. However, in the present invention, when the paste contains fine silver oxide particles, the fine oxide silver particles cause an exothermic reaction, while they are reduced to silver metal by the amine group of the organic silver complex compound. Thus, the deposition of silver particles by a reduction reaction can occur, even when the heating temperature is less than 150° C. Thus, even in a roll process in which a PET substrate having a heat resistance of about 150 □ is used, the conductive paste of the present invention can be used to form conductive patterns.

As described above, the conductive paste of the present invention may be calcined at low temperature, and preferably a temperature of 100-250° C.

In the case of the inventive conductive paste, the physical properties can be easily controlled by changing the chain length of the organic silver salt, etc. Also, using the phenomenon that an exothermic reaction occurs upon the use of silver oxide, it is possible to provide calcination conditions suitable for a roll process in which a general plastic film is used.

The silver source that is contained in the inventive conductive paste may be fine silver oxide particles having a particle size ranging from 200 nm to 30 μm, and preferably a particle size ranging from 200 nm to 2 μm.

When the conductive paste contains silver oxide fine particles, the surface area of the silver oxide fine particles increases with a decrease in the particle size thereof. In such a case, there is an advantage in that a conductive film can be formed through an exothermic reduction reaction at low temperature for a short time. Even if the size of silver oxide particles is large, the silver oxide particles can be powdered to fine particles having a several hundreds of nanometers during a process of preparing the conductive paste, because the organic silver complex compound contained in the conductive paste serves as a lubricant. However, a particle size larger than the upper limit of the above-specific particle size range is not preferred, because there is a limitation on the above-mentioned powdering action. On the other hand, if the silver oxide particles have a particle size smaller than the lower limit of the above-specified particle size range, the dispersibility thereof in the paste can be lowered due to their strong agglomeration tendency, and the workability of the paste can also be deteriorated.

In the conductive paste of the present invention, the organic silver complex compound can be used in an amount of 10-200 parts by weight based on 100 parts by weight of the silver source.

If the weight of the organic silver complex compound is less than 10 parts by weight, the silver source will be difficult to disperse into a stable phase, the printability of the paste can be deteriorated, and the heating of the insufficiently dispersed paste can adversely affect the electrical conductivity of the resulting conductive pattern. On the other hand, if the weight ratio of the organic silver complex compound is more than 200 parts by weight, the interaction between the silver particles will be weakened, and thus the resolution of the pattern when the paste is applied can be deteriorated. Also, the workability of the paste can be spoiled, and the conductive silver film after heating cannot have sufficient thickness.

Meanwhile, the conductive paste of the present invention may comprise a solvent, in addition to the silver source and the organic silver complex compound. The solvent may remain, without being sufficiently removed, after added during the process of allowing the organic silver compound to react with the organic ligand so as to prepare the organic silver complex compound. Alternatively, the solvent may be added in a small amount during the addition of a thickener in order to increase the application workability of the conductive paste and the wettness of a substrate to be applied with the paste. As the additional solvent, a general solvent for paste known to those skilled in the art may be used, and non-limiting examples thereof include high-boiling-point alcohols, such as α-terpineol, β-terpineol and butyl carbitol acetate, alcohol ester, and mixtures thereof. The additional solvent may be added in an amount of 5-30 parts by weight based on 100 parts by weight of the paste.

In the process of preparing the conductive paste by mixing the above-prepared organic silver complex compound with the silver source selected from the group consisting of silver oxide powder, silver powder and silver flake, the mixing method is not specifically limited and may be a method known to those skilled in the art. For example, the paste can be prepared by mixing silver oxide fine particles with the organic silver complex compound and kneading the mixture with a roll-mill or the like. In the kneading process, the silver oxide fine particles can be powdered to a smaller size. As for the size of the fine particles after powdered, the smaller the size is, the more effective the result is, but preferably less than 500 nm. When the conductive paste is applied to a substrate and patterned by screen printing or gravure printing, the largest size of solid particles in the paste should be ⅓ of the mesh pattern. However, as the particle size is smaller and more uniform, a failure in the process can be minimized.

As the silver source, not only silver oxide powder or fine particles, but also silver powder or silver flake can be used without any particular limitation, as long as it can increase the content of silver in the paste.

A substrate in which a conductive film is totally formed or partially patterned thereon, using the inventive conductive paste can be fabricated through a method comprising the steps of:

a) applying the conductive paste on all or patterned part of a substrate; and

b) thermally treating the applied substrate to form a conductive film or pattern.

In the step a), the application method is not specifically limited, as long as it is a method known to those skilled in the art. For example, a method such as screening printing or gravure printing may be used. The application of the paste can be carried out by applying the paste all over the surface of the substrate in a film form without any specific pattern, or applying the paste on part of the substrate in a specific pattern using a mask or the like, and this pattern may be in the form of a conductive interconnection.

In the step b), the substrate having the paste applied thereon can be thermally treated to form a conductive film or conductive pattern. The thermal treatment can be carried out at a temperature of 100-250° C. for 1-30 minutes. When a substrate (e.g., PET film) having low heat resistance is used, the thermal treatment can also be carried out at a temperature of 100-150° C. for 1-10 minutes.

Through the thermal treatment, silver oxide, which has been present as fine particles before the thermal treatment, is self-reduced to silver metal by heating and an exothermic reaction with the organic silver complex compound, so that oxygen is removed and metal silver particles are formed. At the same time, the organic silver complex compound, which has been distributed between the silver oxide particles, is decomposed and reduced to silver, and the deposited silver is bonded with the metal silver particles to form a continuous conductive film or pattern.

Herein, the physical properties of the film can be influenced by the heating conditions. That is, if the heating temperature is high, the bonding rate of the silver particles can be increased, thus lowering the resistivity of the film, and if the heating time is long, the amount of silver particles bonded can be increased, thus lowering the resistivity of the film.

The material of the substrate is not specifically limited, as long as it is a material, to which the film formed by applying the inventive conductive paste can well adhere, and which can resist the heating conditions. A substrate known to those skilled in the art can be used.

For example, a substrate made of a material, such as a metal, ceramic, glass or polymer material, can be used. Preferably, an inorganic material having excellent heat resistance, such as a copper sheet, a copper foil or glass, or a plastic film having relatively low heat resistance, such as PET, PEN or polycarbonate, may be used.

Also, if the adhesion of the conductive paste to the substrate is poor, the surface of the substrate may also be treated with a primer to increase the adhesion.

### BRIEF DESCRIPTION OF THE DRAWINGS

FIG. 1 is a schematic diagram of an Ag(acetate)(ethanolamine)₂ complex forming reaction described in Example 1.

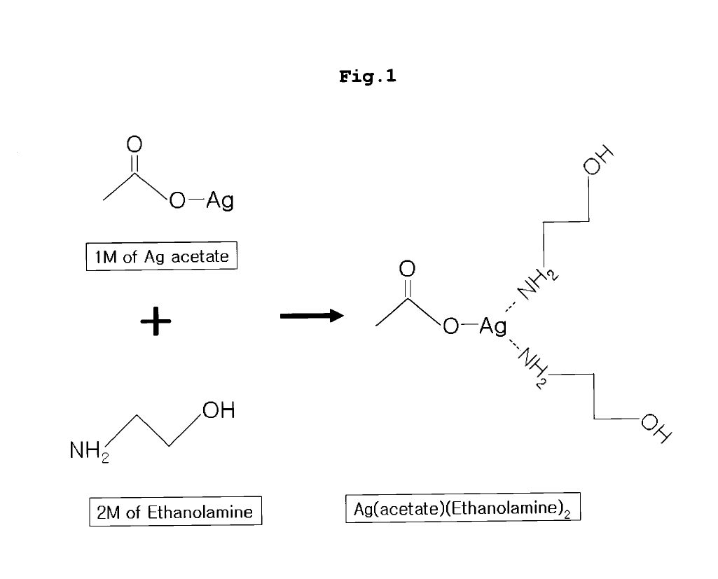

FIG. 2 is a schematic diagram showing the formation of a coordination polymer of Ag palmitate.

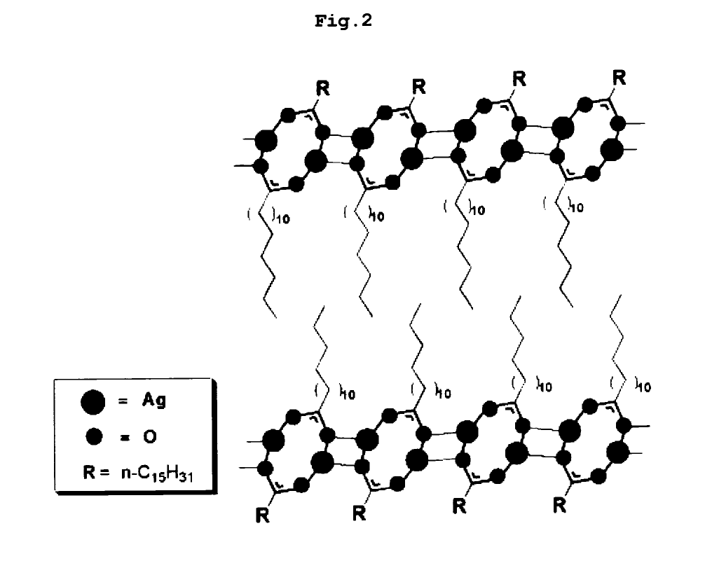

FIG. 3 is a graph showing the TGA (thermogravity analysis) data of Ag(acetate)(ethanolamine)₂ prepared in Example 1.

FIG. 4 is a graph showing the TGA (thermogravity analysis) data of Ag(acetate)(diethanolamine)₂ prepared in Example 2.

FIG. 5 is a graph showing the TGA (thermogravity analysis) data of a substrate having a conductive pattern formed thereon, prepared in Example 8.

FIG. 6 is a graph showing the DSC (differential scanning calorimetry) data of a substrate having a conductive pattern formed thereon, prepared in Example 8.

FIG. 7 is a FESEM (field emission scanning electron microscopy) photograph of a substrate having a conductive pattern formed thereon, prepared in Example 8.

### MODE FOR CARRYING OUT THE INVENTION

Hereinafter, the present invention will be described in further detail with reference to the following examples. It is to be understood, however, that these examples are illustrative only, and the scope of the present invention is not limited thereto.

### Example 1

In a round bottom flask, 1 equivalent of silver (acetate) (Ag(C₂O₂H₃)) and 200 ml of methanol were placed, 2 equivalents of ethanolamine was added thereto with stirring, and the mixture was allowed to react. Then, the solvent was removed by distillation with a vacuum distillation system at about 30° C., and an excess of methanol was removed with diethylether, thus preparing viscous liquid Ag(acetate)(ethanolamine)₂.

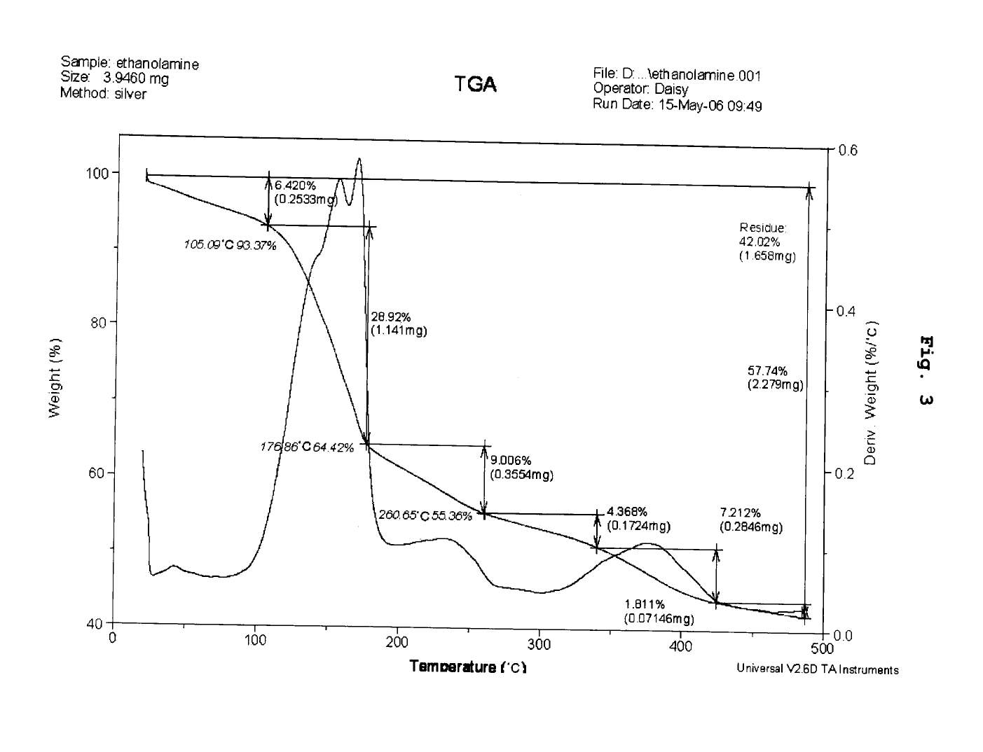

FIG. 3 is a graphic diagram showing the TGA data of the prepared organic silver complex compound.

The results of ¹H-NMR analysis of the prepared organic silver complex compound are as follows: 4.66 (3H), 3.53-3.48 (4H), 2.76(NH), 1.75 (OH), 1.02 (4H). From the analysis results, it could be seen that Ag(acetate)(ethanolamine)₂ was synthesized.

### Example 2

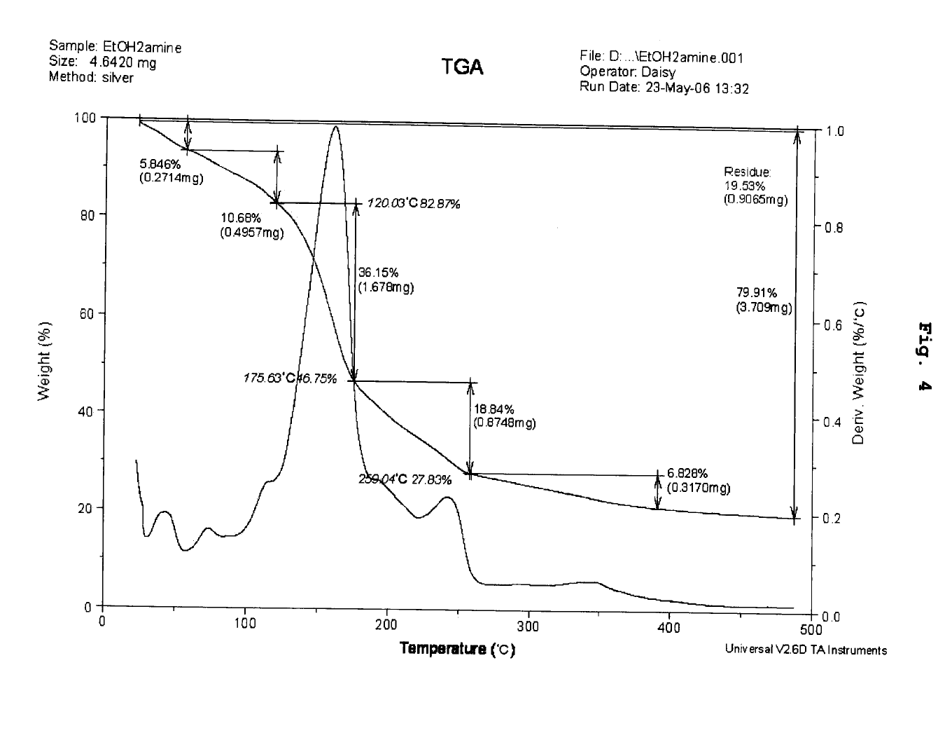

Ag(acetate)(diethanolamine)₂ was prepared in the same manner as in Example 1, except that diethanolamine was used instead of ethanolamine. The TGA data of the prepared organic silver complex compound are shown in FIG. 4.

### Example 3

Ag(propionate)(ethanolamine)₂ was prepared in the same manner as in Example 1, except that silver (propionate) (Ag(C₃O₂H₅)) was used instead of silver (acetate) (Ag(C₂O₂H₃)).

### Example 4

Ag(propionate)(diethanolamine)₂ was prepared in the same manner as in Example 2, except that diethanolamine was used instead of ethanolamine.

### Example 5

Ag(hexanoate)(ethanolamine)₂ was prepared in the same manner as in Example 1, except that silver(hexanoate) (Ag(C₆O₂H₁₁)) was used instead of silver (acetate) (Ag(C₂O₂H₃)).

### Example 6

Ag(decanoate)(ethanolamine)₂ was prepared in the same manner as in Example 1, except that silver(decanoate) (Ag(C₁₀O₂H₁₉)) was used instead of silver(acetate) (Ag(C₂O₂H₃)).

### Example 7

Ag(palmitate)(ethanolamine)₂ was prepared in the same manner as in Example 1, except that silver(palmitate) (Ag(C₁₆O₂H₃₁)) was used instead of silver(acetate) (Ag(C₂O₂H₃)).

### Comparative Example 1

Ag(acetate)(ethanolamine) was prepared in the same manner as in Example 1, except that 1 equivalent of ethanolamine was used per equivalent of silver(acetate) (Ag (C₂O₂H₃)).

### Example 8

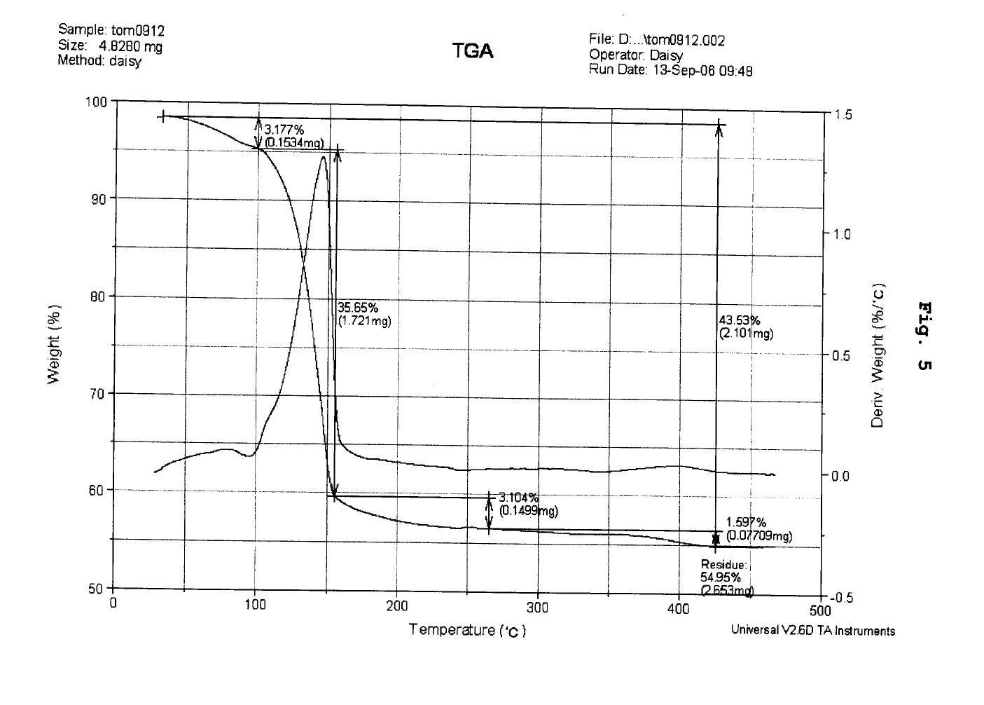

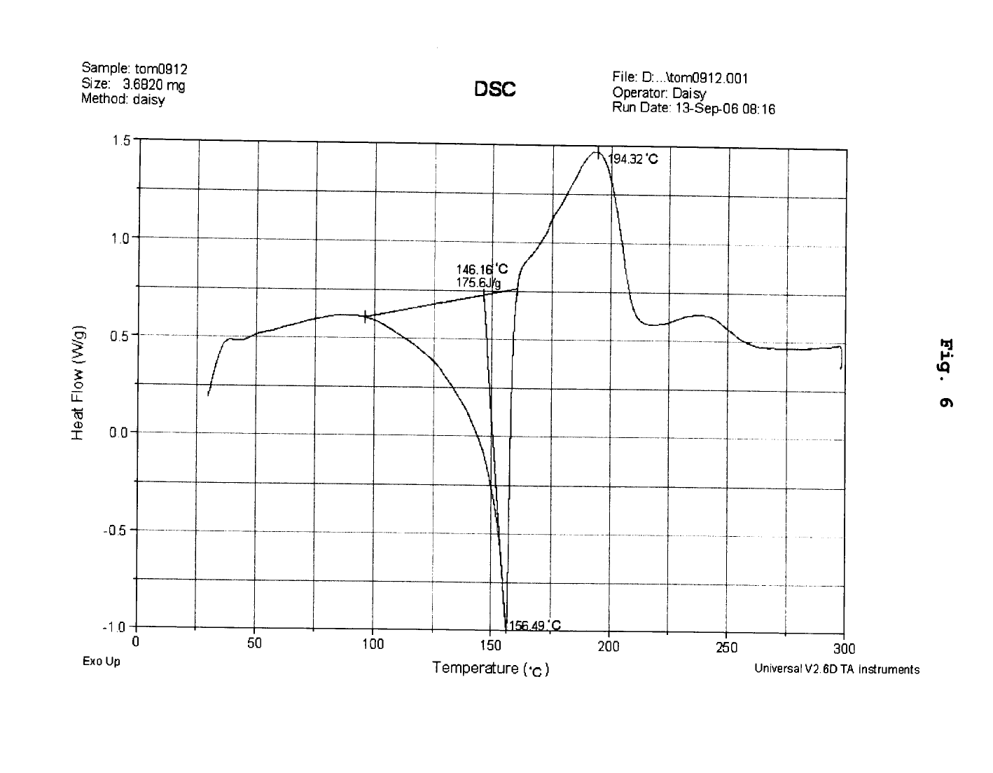

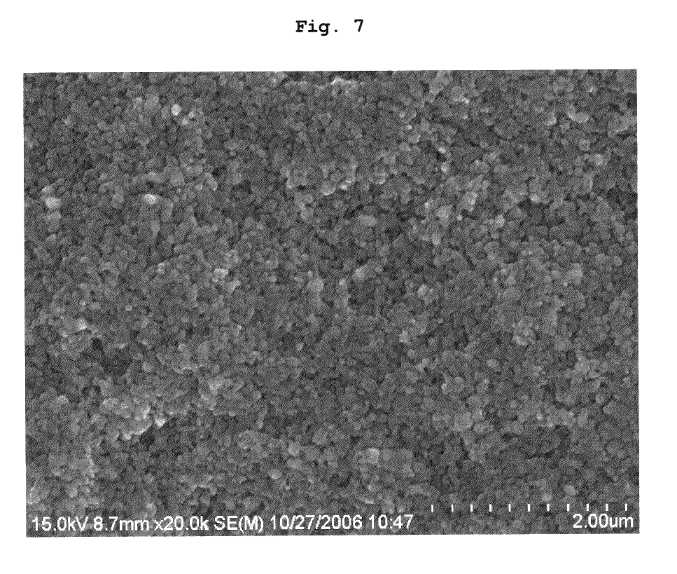

10 g of the room temperature liquid organic silver complex compound prepared in Example 1 was mixed with 40 g of silver oxide. The mixture was powdered and kneaded with a 3-roll mill for 1 hour, thus preparing a conductive paste. The paste was applied on a PET film and calcined at 130° C. for 10 minutes, thus preparing a substrate having a conductive pattern formed thereon. Measurement results for the electrical conductivity of the substrate are shown in Table 1 below. The TGA data, DSC data and FESEM photograph of the substrate are shown in FIGS. 5, 6 and 7, respectively.

The pure organic silver complex compound prepared in Example 1 had a silver content of about 37%, but the silver content of the silver oxide-containing paste prepared in Example 8 could be controlled to 40-90%.

### Example 9

A paste and a substrate having a conductive pattern formed thereon were prepared in the same manner as in Example 8, except that the organic silver complex compound prepared in Example 2 was used.

### Example 10

A paste and a substrate having a conductive pattern formed thereon were prepared in the same manner as in Example 8, except that the organic silver complex compound prepared in Example 3 was used.

### Example 11

A paste and a substrate having a conductive pattern formed thereon were prepared in the same manner as in Example 8, except that the organic silver complex compound prepared in Example 6 was used.

### Example 12

A paste and a substrate having a conductive pattern formed thereon were prepared in the same manner as in Example 8, except that the organic silver complex compound prepared in Example 7 was used.

TABLE 8

| Method for preparing | | | Electrical |
|---|---|---|---|
| organic silver complex | Adhesion after | Pattern | conductivity |
| compound | calcination | printability | (resistivity) |
| Example 8 | Good | Good | 10 μΩ cm |
| Example 9 | Good | Good | 8 μΩ cm |
| Example 10 | Good | Good | 9 μΩ cm |
| Example 11 | Good | Good | 7 μΩ cm |
| Example 12 | Good | Good | 15 μΩ cm |
| Comparative Example 1 | Ordinary | Poor | 120 μΩ cm |

As can be seen in Table 1, the pastes prepared in Examples 8 to 12 can be screen-printed without adding an extra solvent, only containing the organic silver complex compound disclosed in the present invention.

### INDUSTRIAL APPLICABILITY

As described above, the organic silver complex compound according to the present invention has high solubility in a solvent and is present in the liquid state at room temperature. Thus, an extra solvent is not used in a conductive pattern-forming paste containing the complex compound or is used in a small amount, such that the content of silver in the conductive pattern-forming paste can be increased. Also, the conductive pattern-forming paste containing the complex compound has high viscosity, and thus shows excellent stability without adding a dispersant and, at the same time, is easily industrially applied.

Also, in the paste comprising the organic silver complex compound and silver oxide, the reduction of silver oxide to silver metal can occur through an exothermic reaction at low temperature, and thus it is possible to provide a calcining condition of low temperature suitable even for a roll process in which a general plastic film is used. Moreover, the use of an organic solvent such as BCA or terpineol can be inhibited, so that the swelling problem of a silicon resin substrate, caused by the organic solvent, can be minimized.

Therefore, according to the present invention, a paste for low-temperature calcination, having a high silver content, can be provided easily in a cost-effective manner, an electrode pattern having a high silver content can be formed, and the physical properties of the paste can be easily controlled by changing the chain length of the organic silver complex compound. Also, the use of an extra organic solvent is eliminated or the amount of use thereof can be minimized, compared to the prior organic silver salt paste, and thus problems of low density and low silver content, caused by the addition of the organic solvent, and a problem in the difference in film thickness between before and after calcination can be markedly improved.

Although several preferred embodiments of the present invention have been described for illustrative purposes, those skilled in the art will appreciate that various modifications, additions and substitutions are possible, without departing from the scope and spirit of the invention as disclosed in the accompanying claims.

1. An organic silver complex compound in which an organic ligand, containing an amine group (—NH₂) and a hydroxyl group (—OH), is bonded with aliphatic silver (Ag) carboxylate at an equivalent ratio of 2:1 to form a complex.

2. The organic silver complex compound according to claim 1, wherein the aliphatic silver carboxylate is a silver salt (Ag) of a primary or secondary fatty acid having 2-20 carbon atoms.

3. The organic silver complex compound according to claim 1, wherein the organic ligand, containing an amine group and a hydroxyl group, is selected from the group consisting of primary, secondary, tertiary and quaternary amines, substituted with an alcohol group.

4. The organic silver complex compound according to claim 1, which is present in a liquid state at room temperature.

5. The organic silver complex compound according to claim 1, which has a viscosity of 50-2000 cPs at room temperature (25° C.).

6. A conductive paste comprising: a silver source selected from the group consisting of silver oxide powder, silver powder and silver flake; and organic silver complex compound in which an organic ligand, containing an amine group and a hydroxyl group, is bonded with an organic silver compound to form a complex.

7. The conductive paste according to claim 6, wherein the organic ligand, containing an amine group (—NH₂) and a hydroxyl group (—OH), in the organic silver complex compound, is bonded with aliphatic silver (Ag) carboxylate at an equivalent ratio of 2:1 to form a complex.

8. The conductive paste according to claim 6, which has a silver content of 30-90 parts by weight based on 100 parts by weight of the paste.

9. The conductive paste according to claim 6, wherein the silver source is silver oxide fine powder having a particle size of 200 nm to 30 μm range.

10. The conductive paste according to claim 6, which comprises the organic silver complex compound in an amount of 10-200 parts by weight based on 100 parts by weight of the silver source.

11. The conductive paste according to claim 6, which can be calcined at a temperature of 100-250° C.

12. A substrate in which a conductive film is totally formed or partially patterned thereon, using a conductive paste as defined in claim 6.

13. The substrate according to claim 12, which is formed by applying the conductive paste on the substrate, and then thermally treating the applied substrate at a temperature of 100-250° C. for 1-30 minutes.

14. The substrate according to claim 12, wherein the substrate is made of a material selected from the group consisting of a copper sheet, a copper foil, glass, PET, PEN and polycarbonate.

15. A substrate in which a conductive film is totally formed or partially patterned thereon, using a conductive paste as defined in claim 7.

16. The substrate according to claim 15, which is formed by applying the conductive paste on the substrate, and then thermally treating the applied substrate at a temperature of 100-250° C. for 1-30 minutes.

17. The substrate according to claim 15, wherein the substrate is made of a material selected from the group consisting of a copper sheet, a copper foil, glass, PET, PEN and polycarbonate.
